(19) United States
(12) Patent Application Publication
(10) Pub. No.: US 2006/0015803 A1
(43) Pub. Date: Jan. 19, 2006

(54) Systems, methods, and media for updating a knowledge management system

(75) Inventors: Lane Thomas Holloway, Pflugerville, TX (US); Walid M. Kobrosly, Round Rock, TX (US); Nadeem Malik, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/891,775

(22) Filed: Jul. 15, 2004

(51) Int. Cl. G06F 17/00; G06F 17/21

(52) U.S. Cl. 715/501.1

(57) ABSTRACT

Systems, methods and media for updating a knowledge management system are disclosed. More particularly, hardware and/or software for determining or updating a reference count of an object are disclosed. Embodiments include receiving an indication of a request to modify an object, determining if the request includes a change to a hyperlink included in the object, and updating the reference count for the linked object in response to any change in the hyperlink. Further embodiments include receiving an indication of a request to delete an object having a reference count, determining whether other objects link to the object based on the reference count, and deleting the object in the event that no other objects link to the object. Objects may include HTML pages, files, documents, etc.

### FIELD OF INVENTION

The present invention is in the field of data processing systems and, in particular, to systems, methods and media for updating computer-based knowledge management systems.

### BACKGROUND

Personal computer systems are well known in the art. They have attained widespread use for providing computer power to many segments of today's modern society. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more flexible diskette drives, a CD-ROM drive, a fixed disk storage drive (also known as a “hard drive”), a pointing device such as a mouse, and an optional network interface adapter. One of the distinguishing characteristics of these systems is the use of a motherboard or system planar to electrically connect these components together. Examples of such personal computer systems are IBM's PC 300, ThinkCentre, ThinkPad, Aptiva, and IntelliStation series.

The widespread use of PCs in various segments of society has resulted in a reliance on PCs both at work and at home, such as for telecommuting, news, stock market information and trading, banking, shopping, shipping, communication in the form of hypertext transfer protocol (http) and email, as well as other services. PCs are often connected to a network such as the Internet, corporate intranets or other local networks. Such connectivity has facilitated unprecedented amounts of collaboration between individuals, both within organizations and outside organizational structures. This collaboration has resulted in individuals having access to vast amounts of information, making it difficult to find information that is relevant or important to that individual, increasing the need for systems to manage and sort information.

Knowledge management systems address this need by providing a system for cataloging, indexing, and displaying data for users. Knowledge management systems are known in the art, such as the IBM Lotus Discovery Server and DB2 Information Management suite provided by International Business Machines Corporation (IBM). Knowledge management involves the computer-assisted discovery, capture, organization, and sharing of knowledge. Knowledge management system serves to retain and disseminate information to multiple users, such as within a corporation.

A knowledge portal, such as KnowledgeX or IBM Websphere® Portal from IBM, is a software tool used in the practice of knowledge management. Typically, a knowledge portal organizes knowledge into objects and relationships. Objects correspond to real-world entities such as people, places, things, and documents, while relationships link various objects within the knowledge portal. Knowledge in the form of objects is generally stored within a knowledge repository, also known as a knowledge base or knowledge catalog. Sources of knowledge may include human experts, company files, web pages, document management systems, databases, data warehouses, datamarts, and the like. Knowledge portals generally operate on dedicated servers. A client program, such as a World Wide Web (Web) browser or a custom knowledge portal client, may be used to retrieve knowledge from a knowledge portal through constructed questions or queries. The knowledge repository typically contains its elements in electronic form, and the size of the knowledge repository can easily surpass millions of elements. The vastness of the knowledge repository causes users to rely primarily on search engines to retrieve information.

Knowledge management systems may be used to create Internet or intranet sites that link documents or objects written by multiple people into a coherent display of data. The knowledge management system may use specially formatted pages that include the documents or objects, such as pages formatted in the HyperText Markup Language (HTML), which supports hyperlinks between and within documents, as well as a variety of multimedia elements, including graphics, audio and video. These pages may include hyperlinks or other references to other pages within the system to help users navigate the system and easily find information. Often, however, individuals who have responsibility for particular pages delete documents that are being referenced by other pages or documents. This results in broken hyperlinks in the system, causing frustration and lost information for users of the system.

To find broken hyperlinks in a system, an individual could manually try each hyperlink in order to ascertain whether it was still valid, but such a process is very time consuming. An automated crawler may be used to find the broken hyperlinks, which makes the process less time consuming. An automated crawler, however, only finds broken hyperlinks when it runs, so hyperlinks may be broken for a period of time until the next pass of the automated crawler. While either of these processes may find broken hyperlinks, they will not prevent information from being lost, as information that may have been needed was deleted without the knowledge of other users linking to that information.

There is, therefore, a need for an easy and effective system to facilitate updating a knowledge management system, particularly to help reduce broken hyperlinks and lost information in a knowledge management system.

### SUMMARY OF THE INVENTION

The problems identified above are in large part addressed by systems, methods and media for updating a knowledge management system. Embodiments include receiving an indication of a request to modify an object and determining if the request includes a change to a hyperlink included in the object, where the hyperlink is adapted to selectively link the object to a different linked object. Embodiments further include updating the reference count for the linked object in response to any change in the hyperlink, where the reference count provides an indication of all objects linking to the linked object. Further embodiments include determining a reference count for the object in the event that the request to modify the object includes a request to delete the object, and deleting the object in the event that the reference count indicates that no other objects link to the object. Additional embodiments include the embodiments above wherein the change to the hyperlink includes deletion or addition of the hyperlink. Embodiments may include any type of object, such as HTML-formatted pages, documents, etc.

Another embodiment provides a machine-accessible medium containing instructions effective, when executing in a data processing system, to cause the system to perform a series of operations for synchronizing a database on a network. The series of operations generally includes receiving an indication of a request to modify an object and determining if the request includes a change to a hyperlink included in the object, where the hyperlink is adapted to selectively link the object to a different linked object. The series of operations generally further includes updating the reference count for the linked object in response to any change in the hyperlink, where the reference count provides an indication of all objects linking to the linked object. The series of operations may also generally include determining a reference count for the object in the event that the request to modify the object includes a request to delete the object, and deleting the object in the event that the reference count indicates that no other objects link to the object.

A further embodiment provides a knowledge management system. The knowledge management system may include a knowledge portal client manager adapted to interface with a plurality of users on knowledge portal clients and to receive an indication of a request to modify an object, where the request to modify an object includes a request to change one or more hyperlinks in the object. The knowledge management system may further include a reference count update module in communication with the knowledge portal client manager, where the reference count update module is adapted to update a reference count for other objects in response to the request to change one or more hyperlinks in the object to be modified. Alternative embodiments may further include a linking interface module adapted to notify a contact person for least one of the other objects of the request to change on or more hyperlinks in the object.

Another embodiment includes receiving an indication of a request to delete an object having a reference count, where the reference count provides an indication of whether other objects link to the object. The embodiment generally further includes determining whether other objects link to the object based on the reference count, and deleting the object in the event that no other objects link to the object.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for a system for updating a knowledge management system according to one embodiment;

FIG. 2 depicts one embodiment of the knowledge portal of the knowledge management system of FIG. 1;

FIG. 3 depicts an example of a flow chart for handling a request to delete a document in a knowledge management system according to one embodiment;

FIG. 4 depicts an example of a flow chart for handling a request to delete a document in a knowledge management system according to an alternative embodiment;

FIG. 5 depicts an example of a flow chart for updating reference counts of documents in a knowledge management system according to one embodiment; and

FIG. 6 depicts an example of a flow chart for updating reference counts of a linked document in a knowledge management system according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods and media for updating a knowledge management system are disclosed. More particularly, hardware and/or software for determining or updating a reference count of an object are disclosed. Embodiments include receiving an indication of a request to modify an object, determining if the request includes a change to a hyperlink included in the object, and updating the reference count for the linked object in response to any change in the hyperlink. Further embodiments include receiving an indication of a request to delete an object having a reference count, determining whether other objects link to the object based on the reference count, and deleting the object in the event that no other objects link to the object.

The disclosed embodiments help prevent broken links or lost information when objects are deleted in a knowledge management system. Embodiments disclose a reference count associated with an object in the knowledge management system that provides an indication of whether other objects link to the object. In one embodiment, an object cannot be deleted if the reference count indicates that other objects are linking to the object. This helps prevent broken links in the other objects in addition to helping prevent the loss of valuable information if an object is deleted that is needed by others. In other embodiments, the object cannot be deleted unless a query is made to the owners of other linking objects, allowing the owners to agree to the deletion of prevent it from happening.

The disclosed embodiments also help automatically update reference counts for objects in the knowledge management system. Embodiments disclose updating the reference count for any linked objects whenever a hyperlink is changed in a document. If a user, in one example, deletes an object that links to other objects, the reference counts for those other objects (that are subjects of the hyperlink) may be updated to reflect that one less object is now linking to them. By automatically updating reference counts, the reference counts are kept accurate at all times, facilitating their use in the knowledge management system.

While specific embodiments will be described below with reference to particular configurations of hardware and/or software, those of skill in the art will realize that embodiments of the present invention may advantageously be implemented with other substantially equivalent hardware and/or software systems.

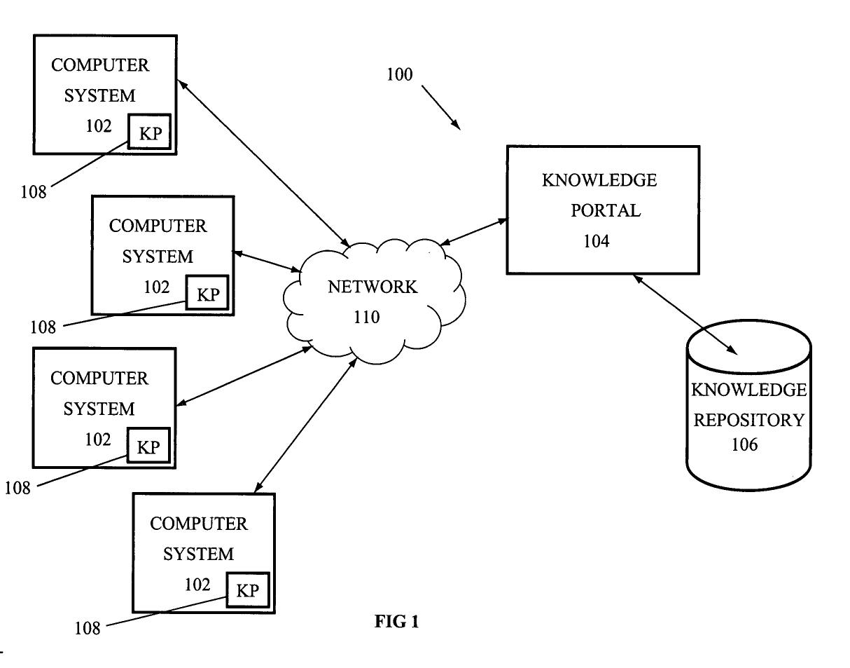

Turning now to the drawings, FIG. 1 depicts an environment for a system for updating a knowledge management system according to one embodiment. In the depicted embodiment, knowledge management system 100 includes a plurality of computer systems 102 in communication with a network 110. Knowledge management system 100 also includes a knowledge portal 104 in communication with network 110 for managing the knowledge management system. Knowledge management system 100 may also include a knowledge repository 106 in communication with the knowledge portal 104 and/or network 110. In knowledge management system 100, the computer systems 102, knowledge portal 104, and knowledge repository 106 may be located at the same location, such as in the same building or computer lab, or may be remote. While the term “remote” is used with reference to the distance between the components of knowledge management system 100, the term is used in the sense of indicating separation of some sort, rather than in the sense of indicating a large physical distance between the systems. For example, any of the components of knowledge management system 100 may be physically adjacent or located as part of the same computer system in some network arrangements.

Network 110 may be any type of data communications channel, such as the Internet, an intranet, a LAN, a WAN, an Ethernet network, a wireless network, a proprietary network, a broadband cable network, etc. In one embodiment, network 110 is a corporate network maintained behind a firewall where computer systems 102, knowledge portal 104, and knowledge repository 106 are all maintained behind the firewall and on the corporate network. Those skilled in the art will recognize, however, that the invention described herein may be implemented utilizing any type of data communications channel.

Computer systems 102 may include personal computers, workstations, servers, mainframe computers, notebook or laptop computers, desktop computers, personal digital assistants (PDAs), set-top boxes, mobile phones, wireless devices, or the like. Each computer system 102 may include a knowledge portal client 108.

A knowledge portal client 108 may be, in one embodiment, a software application that communicates with the knowledge portal 104. In this embodiment, the knowledge portal client 108 may serve as the interface between a user and the knowledge management system 100 and knowledge portal 104, allowing for transmittal of information, such as requests for information or to delete an object, and receipt of information, such as notification messages and search results.

The knowledge portal client 108 may be a Web browser, a custom knowledge portal client, or other type of software, and may be used to retrieve knowledge from a knowledge portal through constructed questions or queries. A Web browser, such as Microsoft Corporation's Internet Explorer or Mozilla, is a client application that allows a user to selectively retrieve and display HTML documents, as well as to selectively follow hyperlinks. A hyperlink is an element within an HTML document that directs a Web browser to another place in the same document, or to an entirely different document, when the hyperlink is followed. Hyperlinks may be attached to words, phrases, icons, and other objects displayed within the document. Typically, a user may follow a hyperlink by selectively “clicking” on the hyperlink with a pointing device, such as a mouse.

The knowledge portal client 108 may also be used to request deletion or modification of an object or other information within the knowledge management system 100. In one embodiment, a user must have permission to delete or modify an object. Permissions may be assigned to particular users, groups of users, be based on ownership or other status, etc.

Knowledge portal 104 may be executing on one or more personal computers, workstations, servers, mainframe computers, notebook or laptop computers, desktop computers, PDAs, set-top boxes, mobile phones, wireless device, or the like. In one embodiment, the knowledge portal 104 may be a server in communication with a plurality of computer systems 102 via network 110. Knowledge portals 104, such as KnowledgeX or IBM Websphere® Portal from IBM, may organize knowledge into objects and relationships. Objects correspond to real-world entities such as people, places, things, and documents, while relationships link various objects within the knowledge portal. Objects may include any pages, documents, files, or anything else that may be stored anywhere within the knowledge management system 100. Knowledge portal 104 may also interface with users on knowledge portal clients 108, such as by receiving and transmitting information to and from the computer systems 102 with knowledge portal clients 108.

In an alternative embodiment, a knowledge portal 104 may serve as a standalone knowledge management system 100, eliminating the computer systems 102 and network 110. In this embodiment, the knowledge portal client 108 may run on the same system as the knowledge portal 104. This embodiment may be particularly useful for users using personal computers, PDAs, etc., where the entire content of the knowledge management system 100 is local. For example, an individual user might have a series of linked objects, such as HTML pages, containing information stored locally on their personal computer, and knowledge management system 100 may provide protection from broken links and lost information. Instead of protecting from other users inadvertently deleting objects, the knowledge management system 100 would protect from the user inadvertently deleting his own objects that are linked to other objects.

Knowledge repository 106, also known as a knowledge base or knowledge catalog, may provide storage for any type of information for the knowledge portal 104, such as objects (i.e., pages, documents, etc.), reference counts, user preferences, administrator settings, or any other information. Knowledge in the form of objects is generally stored within a knowledge repository 106. Sources of knowledge may include human experts, company files, web objects, document management systems, databases, data warehouses, datamarts, and the like. In one embodiment, knowledge repository 106 may be used to store all of the information of the knowledge management system. Knowledge repository 106 may be located anywhere within knowledge management system 100, including as a standalone database, as part of the knowledge portal 104, etc., and may be stored on any type of storage device, such as hard drives, volatile memory, etc.

In one embodiment, information in the knowledge repository 106 may be stored objects in the form of pages in HTML format. In this embodiment, objects may be identified by a Uniform Resource Locator (URL), also commonly referred to as a Web address. A URL may identify the domain name or Internet Protocol (IP) address of the server containing the object, as well as the location of the object within the server. Objects may be stored in any format, including document formats such as Microsoft Corporation's Word, Excel, and PowerPoint, text formats, Adobe Corporation's Portable Object (PDF) format, or any other type of file. Many of these other types of objects, such as Microsoft Word and PDF documents, may also contain hyperlinks to other documents.

In one embodiment of knowledge management system 100, a user on a computer system 102 may open a knowledge portal client 108 so that it is executing on the computer system 102, where computer system 102 is connected to network 110. Using the knowledge portal client 108, the user then typically enters a user name (or other identification) to log in to the knowledge portal 104. After successful login, a user may access the functions of the knowledge portal 104, such by submitting search queries to search the knowledge repository 106, etc. A user with appropriate permissions may modify or delete an object in the knowledge repository 106. For example, a user who owns an object may decide that an object is no longer necessary or relevant and therefore may decide to delete the object. In this embodiment, the knowledge portal 104 may determine whether any other objects link to the one to be deleted. If other objects do link to the object to be deleted, the knowledge portal 104 may prevent deletion of the object so as to prevent the hyperlinks on the other objects from being broken and from the loss of information. In another embodiment, the knowledge portal 104 may delete the object but notify contact personnel for the other objects so that their owners may fix their hyperlinks. In yet another embodiment, the knowledge portal 104 may determine whether contact personnel desire for the object to be deleted, such as by soliciting their input. This helps prevent undesirable loss of information on the deleted object by asking contact personnel for linking objects before the linked object is deleted.

In one embodiment, a reference count associated with the linked object may be used to determine whether other objects link to the relevant object. Any type of count may be used, such as using a ‘0’ when no objects link to the object and adding ‘1’ whenever a new objects link to the object. In this example, a ‘3’ would indicate that three objects link to the object, a ‘1’ would indicate that one does, a ‘0’ would indicate that no objects link to the object, and so on. In an alternative embodiment, other information may be stored in addition to or instead of the simple count, such as location, identification of the linking object, time, owner, contact personnel, etc. of the linking object. The reference count (and any associated information) may be stored within the object itself, such as in an additional field entitled ‘ReferenceCount’ or in an unused or other field. The reference count may also be stored separately from the object, such as in the knowledge portal 104, knowledge repository 106, etc.

In another embodiment, the reference count for an object may be updated by the knowledge portal 104. Whenever an object is opened and/or otherwise modified (created, saved, edited, etc.), it may be searched for links to other objects. The reference counts for those other objects may be updated, as necessary, to reflect the present object. By maintaining reference counts in this or similar fashion, the reference counts may be kept current without having to implement crawlers or other resource-intensive methodologies.

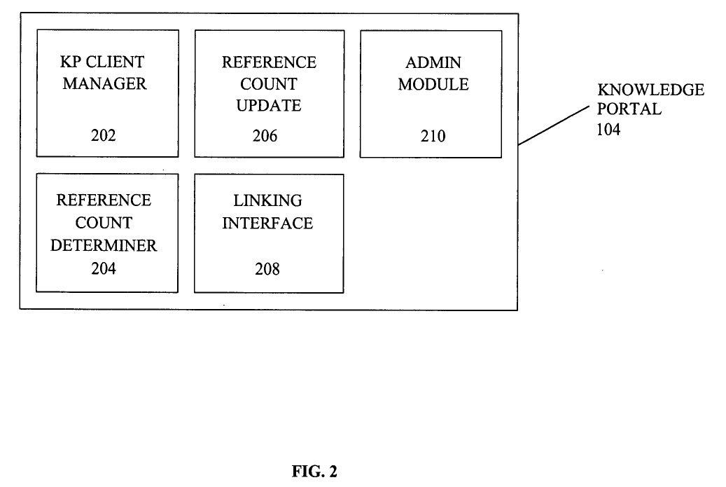

Referring now to FIG. 2, there is shown one embodiment of the knowledge portal 104 of the knowledge management system of FIG. 1. In the embodiment of FIG. 2, the knowledge portal 104 includes a knowledge portal client manager 202, a reference count determiner module 204, a reference count update module 206, a linking interface module 208, and an administration module 210. The knowledge portal client manager 104 may be used to start or stop instances of the knowledge portal client 108, to transmit and receive information from a computer system 102 or knowledge portal client 108, to receive user preferences, to receive requests for deleting objects, or any other function involving the knowledge portal clients 108. In another example, the knowledge portal client manager 104 may be used to transmit an indication of whether an object was deleted or not to the requesting user.

The reference count determiner module 204 may be used to determine the reference count for an object. In one embodiment, the reference count may be determined by locating a reference count within the object itself, such as in a defined field (e.g., ‘ReferenceCount’, etc.) or otherwise. In an alternative embodiment, the reference count may be determined by accessing a database containing objects and reference count. Such a database may be stored at the knowledge portal 104, the knowledge repository 106, at a computer system 102, etc.

The reference count update module 206 may be used to update the reference counts for different objects. In one embodiment, the reference count update module 206 will execute whenever a modification is made to an object, such as editing, saving, creating, etc. of an object. In this embodiment, the reference count update module 206 will review the modified object to determine if there are any new hyperlinks to other objects. If there are new hyperlinks to other objects, the reference count for the linked objects may be modified (i.e., incremented by ‘1’) to reflect the new hyperlink. The determination of whether there are any new hyperlinks may be made based on comparison with a previous version of the object, reference to a file containing a list of hyperlinks for that object, time of hyperlink addition, etc. In an alternative embodiment, all hyperlinks in a modified object are reviewed in order to ascertain whether the hyperlinks are reflected in all of the reference counts. In this embodiment, the reference count update module 206 may review the reference count and associated information for each linked object in order to determine whether the hyperlink from the modified object is taken into account. In this embodiment, the reference count includes information about the linking object, such as an identity of the object, so that a determination of whether the hyperlink is accounted for may be made. In another alternative embodiment, the reference count update module 206 performs its task upon request or at a defined time instead of in response to an object modification.

The linking interface module 208 may be used to provide an interface with any linking objects. For example, the linking interface module 208 may transmit notice to the contact personnel or owners of linking objects that an object has been or will be deleted, may transmit a request (and receive a response) for permission from the contact personnel or owner of linking objects to delete the linked object, etc.

The administration module 210 may be used to access administrative data and to perform administrative tasks. Permissions to different aspects of the knowledge management system 100 may be restricted to those users with the appropriate needs and training. In one embodiment, access to the administration module 210 would be limited to personnel with the appropriate training and authority. In this embodiment, a user with administrator access may add/delete users, passwords, objects, etc. In a further embodiment, permissions for users to modify or delete objects may be defined by individual user, by group or classification of user, etc.

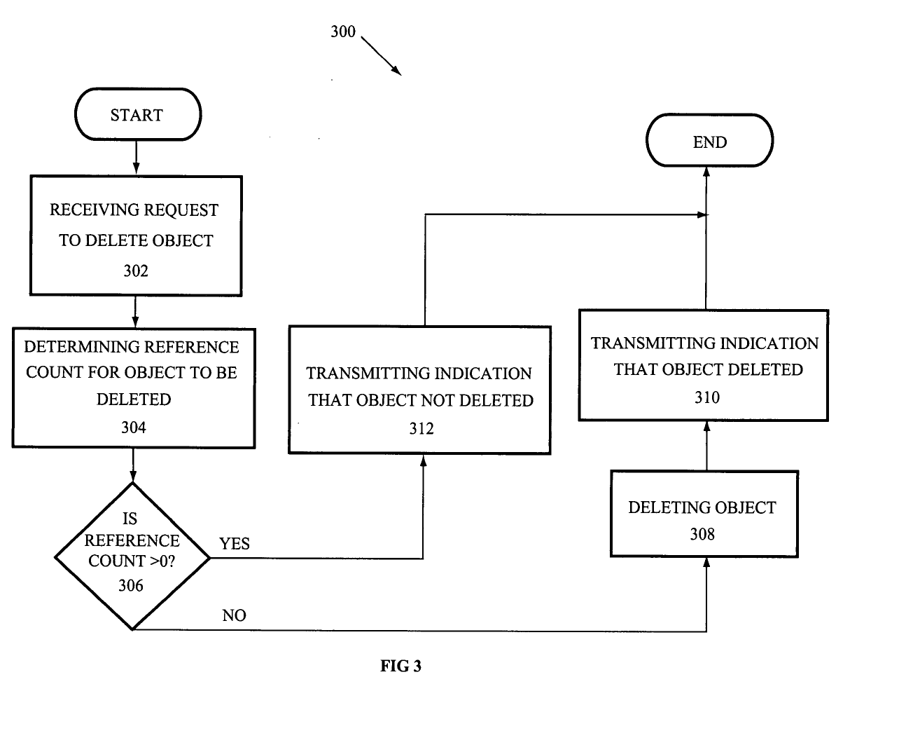

FIG. 3 depicts an example of a flow chart 300 for handling a request to delete an object in a knowledge management system 100 according to one embodiment. The method of flow chart 300 may be performed, in one embodiment, by a knowledge portal 104. Flow chart 300 begins with element 302, receiving an indication of a request to delete an object. The request may be received from a user on a knowledge portal client 108, an administrator, from the knowledge portal 104 itself, from a routine that automatically generated the request, etc. In an alternative embodiment, the indication of a request includes a notification that the object has been or will be deleted, which indicates that a request had been made previously. Flow chart 300 continues to element 304, determining the reference count of an object to be deleted. In one embodiment, the reference count may be determined by accessing the object itself, such as when an indication of the reference count is stored within the object file. The indication of the reference count may be stored in a field of the object, such as a defined reference count field or any other field. Alternatively, the reference count may be located in the file name or anywhere else in the object. In another embodiment, the indication of the reference count may be stored in a separate file, such as an associated reference count file or another file stored with the object. In yet another embodiment, the reference count may be stored in a database, such as the knowledge repository 106.

Flow chart 300 continues to decision block 306, where it is determined whether the reference count indicates that other objects link to the object to be deleted. In one embodiment, if the reference count is greater than zero, it is an indication that other objects are linking to the object to be deleted. If other objects are linking to the object to be deleted, the method continues to element 312, transmitting an indication that the object will not be deleted, and then terminates. In this embodiment, the object is not deleted if any other objects are presently linking to it. This helps prevent broken hyperlinks on those other linking objects and also helps prevent the inadvertent loss of information in the event that information from the object to be deleted is useful to owners of the linking objects.

If it is determined that there are no linking objects (i.e., the reference count equals zero), the method continues to element 308, deleting the object. In one embodiment, element 308 entails deleting the object off of the knowledge repository 106 or knowledge portal 104. In another embodiment, element 308 entails deleting the object off the knowledge management system 100. The method then continues to optional element 310, transmitting an indication that the object is deleted, after which the method terminates. The indication that the object was deleted may be transmitted to the user, administrator, or the routine which requested that the object be deleted.

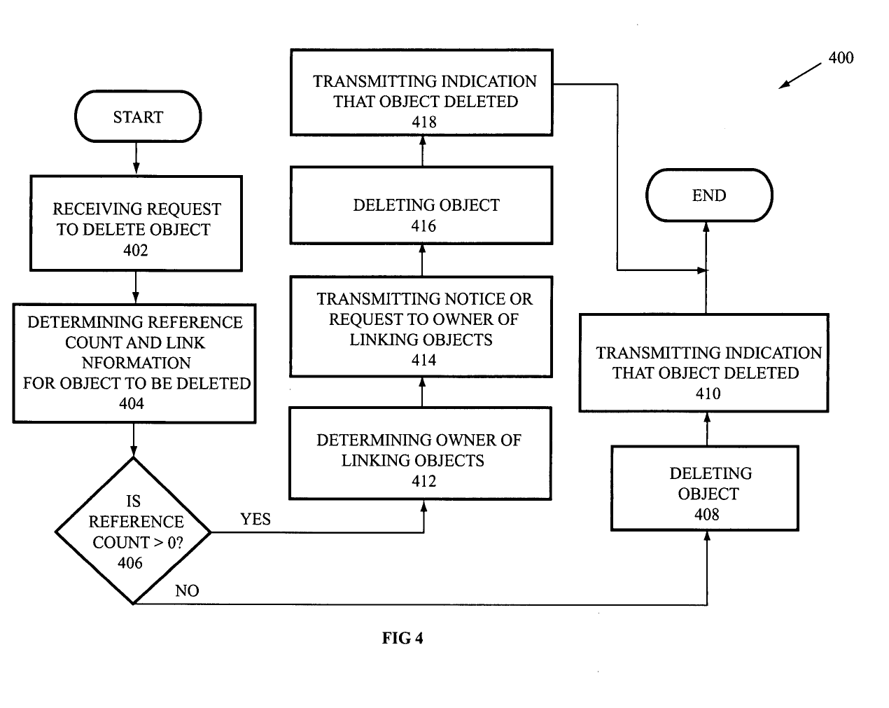

FIG. 4 depicts an example of a flow chart 400 for handling a request to delete an object in a knowledge management system 100 according to an alternative embodiment. The method of flow chart 400 may be performed, in one embodiment, by a knowledge portal 104. Flow chart 400 begins with element 402, receiving an indication of a request to delete an object. The request may be received from a user on a knowledge portal client 108, an administrator, from the knowledge portal 104 itself, etc. In an alternative embodiment, the indication of a request includes a notification that the object has been or will be deleted, which indicates that a request had been made previously. Flow chart 400 continues to element 404, determining the reference count and link information of an object to be deleted. The link information includes information about any objects that are linking to the object to be deleted, such as URLs or other identification for the linking objects, contact or owner information, contact e-mail, the nature of the hyperlink, etc. In one embodiment, the reference count and link information may be determined by accessing the object itself, such as when they are stored within the object file. They may also be stored in a field of the object, such as a defined reference count field, defined link information field, or any other field. Alternatively, the reference count and/or link information may be located in the file name or anywhere else in the object. In another embodiment, the reference count and link information may be stored in a separate file, such as an associated reference count file, link information file, or another file stored with the object. In yet another embodiment, the reference count and/or link information may be stored in a database, such as the knowledge repository 106.

Flow chart 400 continues to decision block 406, where it is determined whether the reference count indicates that other objects link to the object to be deleted. In one embodiment, if the reference count is greater than zero, other objects are linking to the object to be deleted. If other objects are linking to the object to be deleted, the method continues to element 412, determining the owner of the linking objects. The owner of the linking objects may, in one embodiment, be included within the link information received in element 404. In an alternative embodiment, a contact person or anyone else may be used in flow chart 400 instead of an owner. Flow chart 400 continues to element 414, transmitting a notice or a request to the owner of the linking objects. In one embodiment, a notice is transmitted to the owner or other contact person notifying them that the object will be deleted. The notice may indicate that the deletion will be immediate, after a certain time, etc. In another embodiment, a request for permission to delete the object may be sent to one or all owners (or anyone with authority to approve deletion of the object) of linking objects. Upon receipt of permission from each owner permits the function to continue to element 416 in this embodiment. In element 416, the object is deleted, such as off of the knowledge repository 106 or knowledge portal 104. The method then continues to optional element 418, transmitting an indication that the object is deleted, after which the method terminates. The indication that the object was deleted may be transmitted to the user, administrator, or routine which requested that the object be deleted, or the owner or contact person for any linking objects.

If it is determined that there are no linking objects (i.e., the reference count equals zero), the method continues to element 408, deleting the object. In one embodiment, element 408 entails deleting the object off of the knowledge repository 106 or knowledge portal 104. In another embodiment, element 308 entails deleting the object off the knowledge management system 100. The method then continues to optional element 410, transmitting an indication that the object is deleted, after which the method terminates. The indication that the object was deleted may be transmitted to the user, administrator, or routine which requested that the object be deleted.

Flow chart 400 provides a modified method of handling a request to delete an object in a knowledge management system 100 when compared to flow chart 300. The method of flow chart 400 provides additional functionality by either providing notice or requesting permission from the owners of linking objects. This allows the owners of the linking objects to change their hyperlinks, reducing the risk of broken hyperlinks, or to copy or otherwise use the information from the linked object before it goes away. In one embodiment, the object may not be deleted at all without permission from all owners of linking objects. These embodiments provide an additional benefit over flow chart 300 by giving other users input into whether an object is deleted or not.

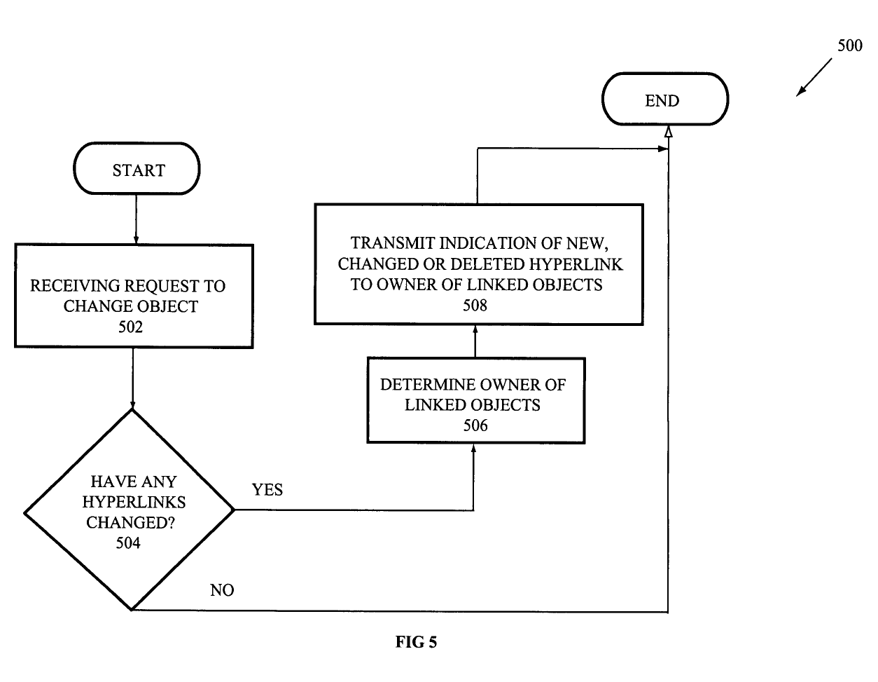

FIG. 5 depicts an example of a flow chart 500 for updating reference counts of objects in a knowledge management system 100 according to one embodiment. The method of flow chart 500 may be performed, in one embodiment, by a knowledge portal 104. In another embodiment, flow chart 500 may be performed by a knowledge portal client 108 executing on, for example, a computer system 102. Flow chart 500 begins with element 502, receiving an indication of a request to change (e.g., add, modify or delete) an object. The request may be received from a user on a knowledge portal client 108, an administrator, from the knowledge portal 104 itself, etc. In one embodiment, flow chart 500 may be performed whenever an object is modified in any way, such as when it is edited, changed, saved, deleted, etc. Flow chart 500 continues to decision block 504, determining if any hyperlinks in the object have changed, such as y being added, removed, modified, etc. This may be accomplished by comparing the new version of the object with an older one, referencing a list of previous hyperlinks, based on a time when a hyperlink was entered in the object, etc. If no hyperlinks have changed, been added or been deleted, the method simply terminates. If there has been a change to the hyperlinks, the method continues to element 506. In one alternative embodiment, all of the hyperlinks in the object are treated as new ones, with the method simply continuing to element 506.

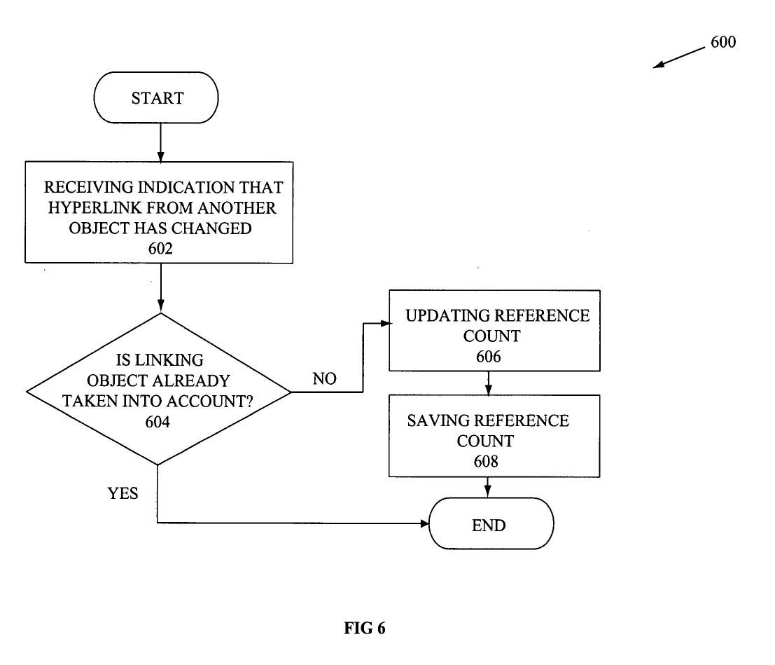

Flow chart 500 continues to element 506, determining the owner of any new, changed or deleted linked objects. Owners may be determined via lookup table, via information contained in the object or file, from the knowledge repository 106, or any other fashion. In element 508, an indication of the new, changed, or deleted hyperlink may be transmitted to the owners of the linked objects. In an alternative embodiment, the indication of the new, changed or deleted hyperlink may be transmitted to the knowledge portal 104. After receiving indication of a new, changed, or deleted hyperlink, the owner of the linked objects (or the knowledge portal 104) may then update the reference count for the linked objects as necessary, as described in more detail in relation to FIG. 6.

FIG. 6 depicts an example of a flow chart 600 for updating reference counts of a linked object in a knowledge management system 100 according to one embodiment. The method of flow chart 600 may be performed, in one embodiment, by a knowledge portal 104. In another embodiment, flow chart 600 may be performed by a knowledge portal client 108 executing on a computer system 102. Flow chart 600 begins with element 602, receiving an indication that a hyperlink from another object has changed, such as when a hyperlink has been added or deleted. The request may be received from a user on a knowledge portal client 108, an administrator, from the knowledge portal 104 itself, etc., or a computer system performing element 514 of FIG. 5.

Flow chart 600 continues to decision block 604, determining if the linking object is already accounted for in the reference count. In one embodiment, review of information associated with the reference count may provide a determination of whether the linking object is taken into account in the reference count. For example, if a reference count contains information, such as an URL, for each linking object, it would be straightforward to determine whether a new indication of a linking object was already part of the current reference count. Any methodology may be used to determine if the linking object has already been taken into account.

If the linking object has already been taken into account, the flow chart simply terminates. If the linking object has not been taken into account, flow chart 600 continues to element 606, updating the reference count. In one example, if it was determined that the linking object was a new one, the reference count would be incrementing by one. In another example, if it was determined that the object that is no longer linking was part of the reference count, the reference count would be decremented by one. The method then continues to optional element 608, saving the reference count. In an alternative embodiment, other information may also be saved, such as the time of linking or saving, the URL or identifies for the linking object, etc.

The methods of FIGS. 5 and 6 provide a straightforward mechanism for updating the reference counts for any objects whenever any particular object is modified. When a new hyperlink is added to an object, the reference count for that linked object may be automatically updated using the methodologies described in FIGS. 5 and 6. Similarly, if an object is deleted, the reference counts for any objects to which it was linking would be updated accordingly. By updating the reference counts continuously whenever any new hyperlinks are added or objects (and thus hyperlinks) are deleted, the reference counts remain very accurate and the need for large-scale updates (such as by automated crawlers) may be eliminated.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for updating a knowledge management system. It is understood that the form of the invention shown and described in the detailed description and the drawings are to be taken merely as examples. It is intended that the following claims be interpreted broadly to embrace all the variations of the example embodiments disclosed.

What is claimed is:

1. A method for updating a knowledge management system, the method comprising:
receiving an indication of a request to modify an object;
determining if the request to modify the object includes a change to a hyperlink included in the object, the hyperlink being adapted to selectively link the object to a different linked object; and
updating a reference count for the linked object in response to the change of the hyperlink, the reference count providing an indication of all objects linking to the linked object.

2. The method of claim 1, further comprising saving the updated reference count.

3. The method of claim 1, further comprising determining if the changed hyperlink is accounted for in the reference count for the linked object.

4. The method of claim 1, further comprising:
determining a reference count for the object in the event that the request to modify the object includes a request to delete the object; and
deleting the object in the event that the reference count indicates that no other objects link to the object.

5. The method of claim 1, further comprising:
determining a reference count for the object in the event that the request to modify the object includes a request to delete the object; and
transmitting an indication that the object was not deleted in the event that the reference count indicates that other objects link to the object.

6. The method of claim 1, wherein the change to the hyperlink includes deletion of the hyperlink.

7. The method of claim 1, wherein the change to the hyperlink includes addition of the hyperlink.

8. The method of claim 1, wherein the reference count is updated by incrementing the reference count by one for each added hyperlink.

9. The method of claim 1, wherein the reference count is updated by decrementing the reference count by one for each deleted hyperlink.

10. The method of claim 1, wherein the object is a HTML formatted page.

11. The method of claim 1, wherein the object is a document.

12. The method of claim 1, further comprising determining an owner for the linked object.

13. A machine-accessible medium containing instructions effective, when executing in a data processing system, to cause said data processing system to perform operations comprising:
receiving an indication of a request to modify an object;
determining if the request to modify the object includes a change to a hyperlink included in the object, the hyperlink being adapted to selectively link the object to a different linked object; and
updating a reference count for the linked object in response to the change of the hyperlink, the reference count providing an indication of all objects linking to the linked object.

14. The machine-accessible medium of claim 13, further comprising saving the updated reference count.

15. The machine-accessible medium of claim 13, further comprising determining if the changed hyperlink is accounted for in the reference count for the linked object.

16. The machine-accessible medium of claim 13, further comprising:
determining a reference count for the object in the event that the request to modify the object includes a request to delete the object; and
deleting the object in the event that the reference count indicates that no other objects link to the object.

17. The machine-accessible medium of claim 13, further comprising
determining a reference count for the object in the event that the request to modify the object includes a request to delete the object; and
transmitting an indication that the object was not deleted in the event that the reference count indicates that other objects link to the object.

18. The machine-accessible medium of claim 13, wherein the change to the hyperlink includes deletion of the hyperlink.

19. The machine-accessible medium of claim 13, wherein the change to the hyperlink includes addition of the hyperlink.

20. The machine-accessible medium of claim 13, wherein the reference count is updated by incrementing the reference count by one for each added hyperlink.

21. The machine-accessible medium of claim 13, wherein the reference count is updated by decrementing the reference count by one for each deleted hyperlink.

22. The machine-accessible medium of claim 13, wherein the object is a HTML-formatted page.

23. The machine-accessible medium of claim 13, wherein the object is a document.

24. An knowledge management system, the system comprising:
a knowledge portal client manager, the knowledge portal client manager being adapted to interface with a plurality of users on knowledge portal clients, wherein the knowledge portal client manager is further adapted to receive an indication of a request to modify an object, wherein further the request to modify an object includes a request to change one or more hyperlinks in the object; and
a reference count update module in communication with the knowledge portal client manager, the reference count update module being adapted to update a reference count for other objects in response to the request to change one or more hyperlinks in the object to be modified.

25. The system of claim 24, further comprising a linking interface module, the linking interface module being adapted to notify a contact person for at least one of the other objects of the request to change one or more hyperlinks in the object.

26. The system of claim 24, wherein the object is a HTML-formatted page.

27. The system of claim 24, wherein the object is a document.

28. A method for updating a knowledge management system, the method comprising:
receiving an indication of a request to delete an object, the object having a reference count, wherein the reference count provides an indication of whether other objects link to the object;
determining, based on the reference count, whether the other objects link to the object; and
deleting the object in the event that no other objects link to the object.

29. The method of claim 28, further comprising transmitting an indication of whether the object was deleted.

30. The method of claim 28, wherein the object to be deleted is a page in HTML format.

31. The method of claim 28, wherein the object to be deleted is a document.
